(19) United States
(12) Patent Application Publication
(10) Pub. No.: US 2003/0126752 A1
(43) Pub. Date: Jul. 10, 2003

(54) Right angle measuring design

(76) Inventors: Darrell Holmes Brandon, Templeton, CA (US); Edwin Oliver Brandon, Colorado Springs, CO (US)

Correspondence Address: DARRELL H. BRANDON, 993-D LAS TABLAS RD., TEMPLETON, CA, 93465, US

(21) Appl. No.: 10/038,086

(22) Filed: Jan. 7, 2002

(51) Int. Cl. G01B 3/10

(52) U.S. Cl. 33/494; 33/759

(57) ABSTRACT

The printing or digital displaying of sets of two numbers in consecutive order, in one of three configurations that along with the existing number, printed or designed, form in proportion two of the three sides of a 3 by 4 by 5 increment 90-degree right-angled triangle, or any other right triangle where the three sides form increments in whole numbers or whole numbers and simple fractions, on or in all types of measuring devices that measure distance or angles in some form of increments including tape measure blades, optical reader tape measures, rulers yard sticks etc. The printing or digital display of the cosine formula for finding angles when two sides of a triangle are known and indicating the cosines for angles of 90 degrees or less.

### CROSS REFERENCE TO RELATED DESIGNS

### U.S. Patent Documents

U.S. Pat. No. 4,750,270 Kundikoff Jun. 14, 1998 Measuring ruler D10/71

Des U.S. Pat. No. 402,216 Gilliam Dec. 8, 1998 Tape measure blade D10/71

Des U.S. Pat. No. 342,210 Grossman Dec. 14, 1993 Tape measure blade D10/71

U.S. Pat. No. 4,930,227 Kechpel Jun. 5, 1990 Coilable tape rule D10/74X

U.S. Pat. No. 4,575,943 Braum Mar. 18, 1986 Right angle measure 33/138

Des U.S. Pat. No. 257,008 Hildebrant Sep. 23, 1980 Tape rule blade D10/71

Des U.S. Pat. No. 247,878 Covey May. 16, 1978 Tape rule blade D10/71

U.S. Pat. No. 5,894,678 Masrelfez/Andermo Apr. 20, 1999 Electric tape measure 33/762

U.S. Pat. No. 4,890,392 Komura/Hirai Jan. 2, 1990 Digital tape measure 33/762

U.S. Pat. No. 4,427,883 Betensky/Hildebrandt Optical sensing for Jan. 24, 1984 tape rules 250/237

U.S. Pat. No. 4,161,781 Hildebrandt Jul. 17, 1979 Digital tape rule 364/562

### DESCRIPTION

### BACKGROUND OF THE INVENTION

1. Field of the invention

The invention applies as indicia added to measuring devices that display indicia in increments in either the English or metric system. The added indicia will make it easier to form ninety degree angles by using the age-old Pythagorean Theorem (a²+b²=c²). Included is a table of angles and their cosines (trigonometry) that we use to form other angles. The invention is an improvement over the different processes of finding angle measurements that have been used in the past.

2. Prior art

People in the building or construction trades, carpenters, engineers, private home builders etc. are always faced with the problem of laying out foundations, walls etc. that are 90 degrees square. There are two processes used to accomplish this.

One process is by using a transit that requires setting up the instrument over a given corner point established with the use of a plumb bob, moving the scope to the 0-degree angle, focusing on a plumb bob held by an assistant who marks the point to snap the line to form one side of the triangle. The operator turns the scope 90 degrees, focuses on a plumb bob held by an assistant who marks the location of the second side of the triangle. This forms the 90-degree angle.

The other process is by using the tape measure and knowing two or three progressive sets of three predetermined numbers that have their origin from the Pythagorean Theorem (a²+b²=c²). The numbers most commonly used are always in three foot increments, 3 ft. 4 ft. 5 ft. or 6 ft. 8 ft. 10 ft. that is memorized from the theorem and forms a special 90-degree right triangle. The special triangle, often referred to as the three four five right triangle, is used for two reasons. One reason is because, if whole numbers are used then the solution will be a whole number. The second reason is that the three four five triangle is the most practicable because the three sides are closer together in length than any other right triangle where all three numbers are whole numbers. However because the smaller sets are so easy to remember and because these numbers are passed down from carpenter to carpenter very few even know the formula they are derived from.

The two smaller numbers on the tape measure scale are used to layout two sides of the triangle and the third larger number, the hypotenuse, are laid out connecting the ends of the other two sides. This forms a 90-degree right triangle. The tape measure process is the most commonly used because it requires no bulky extra expensive equipment, extra set up time, is much faster, more accurate and is easer to operate.

As an example if a carpenter and an assistant were to lay out a foundation that measured 30 ft, by 40 ft. this is the way they would do it. They would start by measuring the long side and snapping a line 40 ft. long. What is usually the case with carpenters they would probably use the six eight ten triangle and would mark a point at 8 ft. from the start point on the 40 ft. line. They would then estimate a 90-degree angle and measure out 6 ft. on the short side and mark it by swinging a short arc. On the 8 ft. dimension on the 40 ft. line they would measure out 10 ft. and mark the point where it intersected the short arc of the 6 ft. dimension. This point forms the right triangle. They then would measure out 30 ft, for the short dimension and snap a line through the point of intersection. From the end of the 30 ft. line they would measure out another 40 ft. line perpendicular to the other 40 ft. line and mark a short arc. From the end of the first 40 ft. line they would measure out 30 ft. and mark it where it intersected the short arc. Then they would snap the two lines crossing that intersection point forming a 30 ft. by 40 ft. rectangle. To check it for square they would measure the two diagonals to make sure they were the same length. If they were not exactly the same length, a minor adjustment would square the rectangle.

### BRIEF SUMMARY OF THE INVENTION

The invention applies to all types of measuring devices, retractable tape measure blades of various sizes and lengths and digital displayed tape rules. However, the invention is not limited to these alone as it applies to rulers and other measuring devices as well. For most types of measuring devices and their manufacturing, it would simply mean the additional printing of a set of two numbers in progressive order and in the right increments. The numbers would be printed in the open space, in the center of the blade, slightly above the appropriate existing number. The numbers would be smaller than the existing numbers, probably in a contrasting color and printed from the beginning to the end of the measuring device.

A set of two numbers represents two sides of a particular type of right triangle where the third side of the triangle is the existing number, as an example, on a tape measure blade. There are three different possible sets. The first set is where the two newly printed numbers are the base and altitude of the triangle and the hypotenuse is the existing number. The second set is where the two newly printed numbers are the base and hypotenuse and the altitude is the existing number. The third set is where the altitude and hypotenuse are the newly printed numbers and the base number (smallest number of the three) is the existing number. All three sets of numbers form the same special right-angled triangle where each set has a different existing number.

The same above process above applies to that part of the digital tape rule that displays a digital window. It would display two smaller numbers in digital form above the larger digital displayed number. The blade would also have the additional numbers printed on it.

The cosine formula and the table of degrees (used as an aid to form angles other than ninety degrees) are displayed on the back of tape measure blades, on the sides of retractable tape measures or as a supplement hand out to the measuring device. In the case of displaying it on the sides or side of a tape measure it would be more practical to display it in increments of every five degrees from five degrees to eighty-five degrees because of the limited space available.

This special right triangle, based on the Pythagorean theorem, is the most practical for constructing a 90-degree angle. This is because of it's proportion and the three sides are always in whole numbers or whole numbers and simple fractions. It enables a carpenter as an example, to layout and square a foundation in increments of three inches or less. He does not need to do any figuring, memorize any numbers or use of any extra equipment as the three necessary measurements for any size foundation are printed or displayed right on the measuring device.

The above patent reference U.S. Pat. No. 4,575,943, by Baum, is some what similar to the invention because it is also based on the Pythagorean theorem. However it involves the use of three separate tape measures that probably were determined not to be practical for manufacturing the invention.

### BRIEF DESCRIPTION OF THE DRAWINGS

Most of the following figures show in the three possible formats the location and approximate size of the two numbers to be printed on a typical tape measure blade that along with the third existing number form a right angle triangle.

FIG. 1.

1. This shows the two newly printed numbers (reference character 1.) representing the base and altitude of the triangle. The base being printed on the left and the altitude printed on the right. The spacing of the newly printed numbers is every five inches starting with the five-inch dimension and is typical for the full length of the tape measure blade. The newly printed numbers are always whole numbers without fractions. The larger existing numbers represent the hypotenuse.

FIG. 2.

1. This has the same above description and character number except the spacing of the newly printed numbers is every four inches starting with the four-inch dimension. The base numbers of the triangle are to be printed on the left and the hypotenuse numbers are printed on the right. The newly printed numbers are whole numbers without fractions. The larger existing numbers represent the altitude side of the triangle.

FIG. 3.

1. This has the same description and character number except the spacing of the newly printed numbers is every three inches starting with the three-inch dimension. The altitude is printed on the left and the hypotenuse on the right. The newly printed numbers are also always whole numbers without fractions. The larger existing numbers now represent the base of the triangle.

FIG. 4.

1. This has the same description and character number and represents the same triangle as FIG. 2. except the spacing of the newly printed numbers is every two inches starting with the two inch dimension and in some dimensions the include an additional ½ inch fraction. The base is printed on the left and the hypotenuse on the right. The larger existing numbers represent the altitude of the triangle.

FIG. 5.

1. This has the same description and character number and represents the same triangle as FIG. 2 and FIG. 4. The spacing of the newly printed numbers is every one inch starting with the one inch dimension and in some locations the numbers include ¾ inch, ½ inch or ¼ inch fractions. The larger existing numbers represent the altitude of the triangle.

FIG. 6.

1. This figure shows a metric scale and has the same description and character number and is in the same triangular configuration as FIG. 2. 4. and 5. The newly printed numbers are printed in centimeters and centimeters and millimeters with the base printed on the left and the hypotenuse printed on the right. Both numbers are printed below the existing number. The existing number represents the altitude side of the triangle.

FIG. 7

1. This figure has the same description and character number and is in the same triangular form as FIG. 3. The altitude is printed on the left and the hypotenuse on the right. The tape measure represents a fifty foot, one hundred foot or longer tape measure where the existing numbers are printed in feet and feet and inches. The tape measures are usually made of steel, smaller in width and not spring wound. The newly printed altitude and hypotenuse are printed in feet or feet and inches with the altitude printed on the left and the hypotenuse printed on the right. The existing printed numbers represent the base dimension.

FIG. 8.

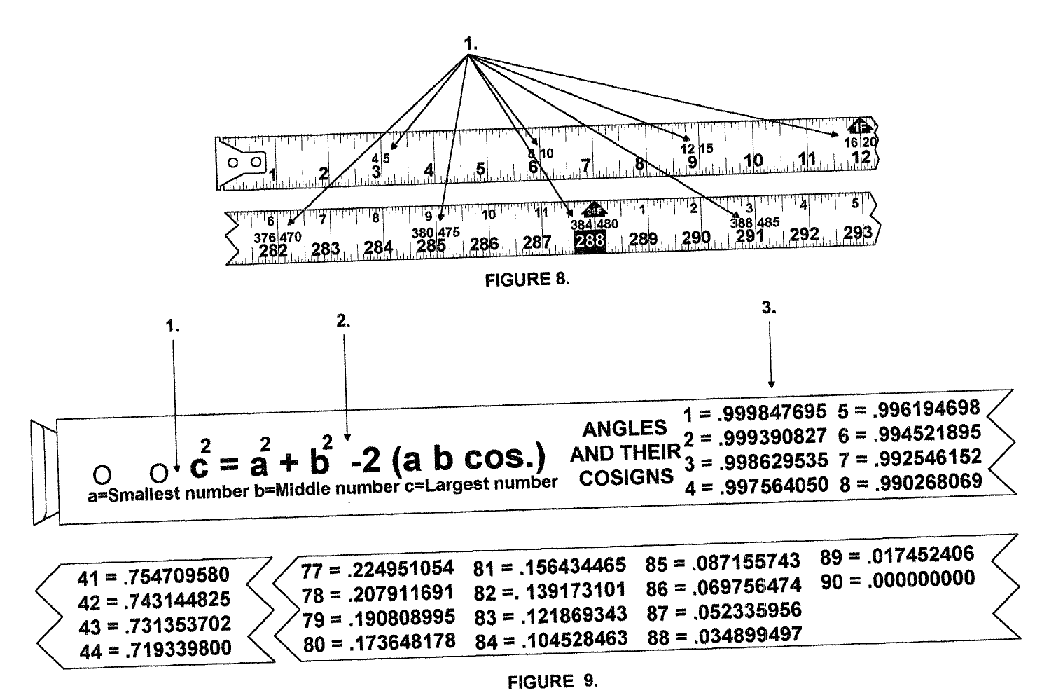

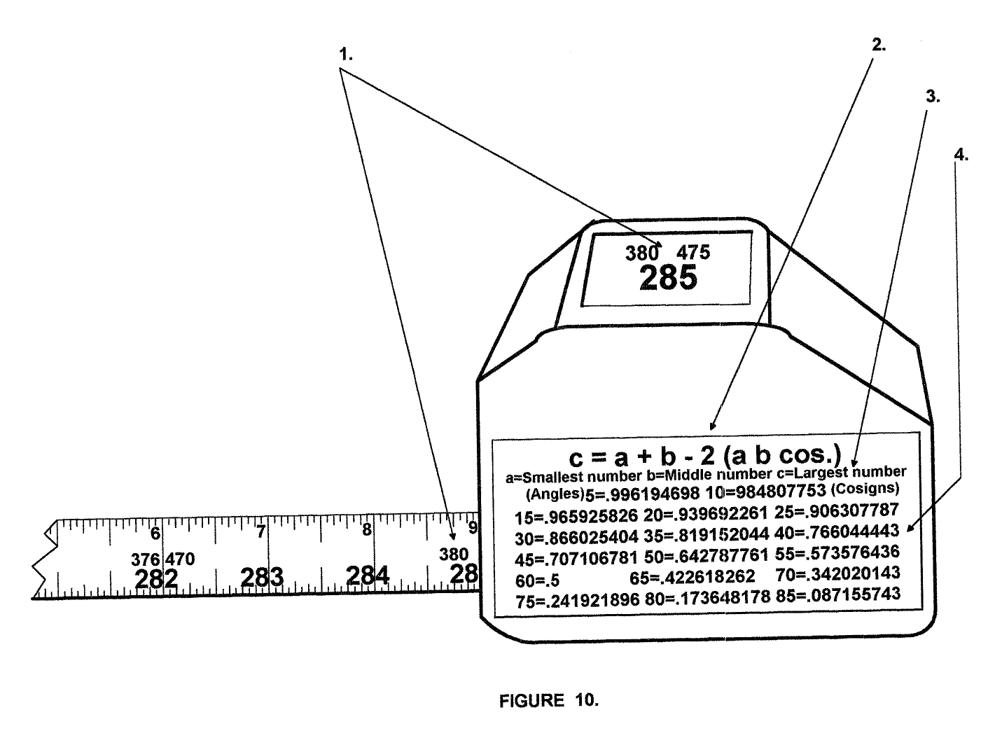

1. This is a duplication of FIG. 3. and is shown as the inventors choice of the three triangular examples for tape measure blades that use the standard measuring system. The most practical for a tape measure blade using the metric system is FIG. 7. For smaller measuring devices, rulers, yard sticks etc. the most practical triangular example is the one shown in FIG. 5.

FIG. 9. This shows an example of printing a formula on the back side of the tape measure blade. Character number 2. is the cosine formula, number 3. defines the relationship between a, b, and c, and the three printed numbers on the tape measure blade and number 4. is a table of angles and their cosines. It could also be printed on paper to be included with a measuring device or on the side of a tape measure. This is the formula for constructing other angles besides 90-degree angles.

FIG. 10. This shows a typical digital tape measure where the three numbers are printed on the blade and also displayed in digital form in the digital display window.

1. Shows the printed three numbers on the blade of a digital tape measure and the three displayed numbers in digital form displayed in the window.

2. Shows the cosine formula to use for finding angles with other than 90-degrees. This formula is the only way to form angles other than 90 degrees, other than by the use of a transit or protractor.

3. Shows the definition of the three sides of a triangle in relation to three applicable numbers. The letter a=smallest number (base), b=middle number (altitude) and c=largest number (hypotenuse).

4. Shows a table of all the angles and their cosines from one degree to ninety degrees. This mathematical formula with the printed cosines up to 90-degrees, allows a carpenter to construct any angle, but would require a small calculator that has the square-root function. Even the most simple calculators have the square-root function. In the case of the digital tape measure (FIG. 10) the display could be in the form of print, an added plate, embossed or engraved.

### DETAILED DESCRIPTION OF THE INVENTION

The invention is based on the Pythagorean Theorem (a²+b²=c²) that produces ninety degree triangles, called right angle triangles This invention illustrates the use of a specific right triangle where a=4 units, b=3 and c=5. In geometry, a, is called the altitude, b, the base and c, the hypotenuse. This invention uses these three definitions to describe the numbers called out in the attached figures.

The purpose of using this specific right triangle is two fold. One, the resulting numbers are in whole numbers or whole numbers and simple fractions, Two, the three sides are closer in proportion than any other right triangle that produces whole numbers.

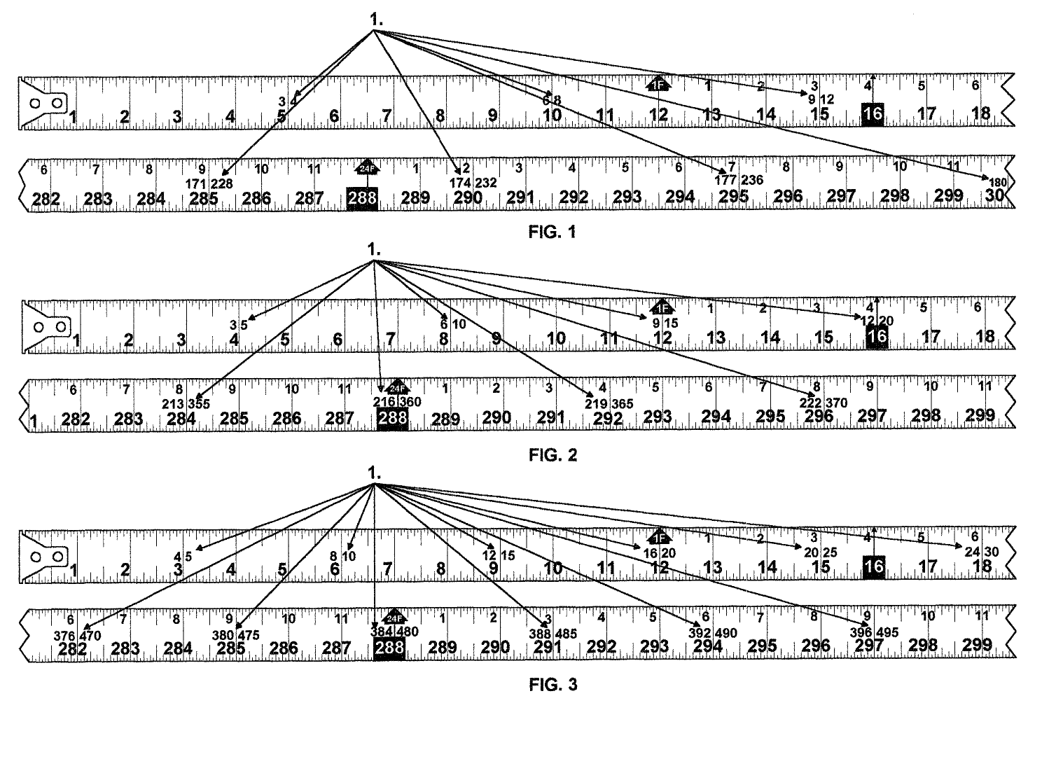

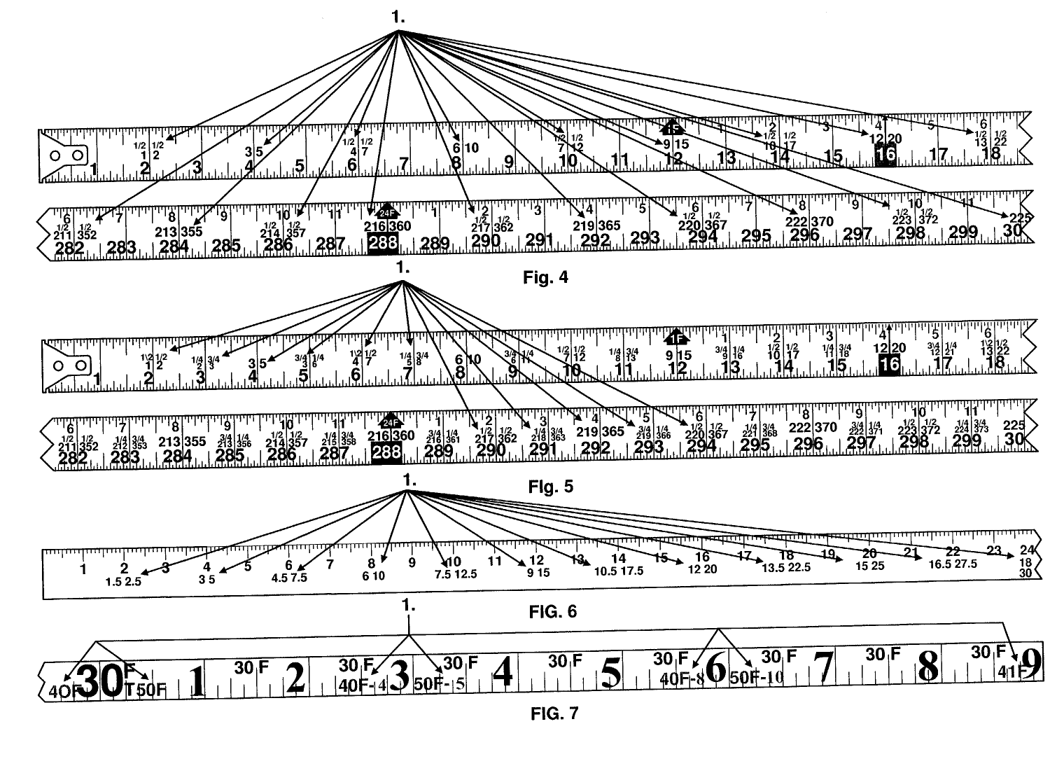

There are only three different combinations of the invention shown. First one is FIG. 1. where the hypotenuse side of the triangle is the numbers already printed on the tape measure blade, or other measuring devices, or in the form of digital read out measurements that measure lengths. Second one, shone in FIGS. 2, 4, 5, and 6, is where the altitude side is the numbers already printed. Third one, shone in FIGS. 3, 7, and 8, is where the base side is the numbers already printed.

The invention as it applies to tape measures is the application of printing a series of two numbers equally spaced on different types of tape measures that display a scale to measure distances. The attached figures illustrate the application of these two numbers over printed on typical tape measure blades that have been previously designed with a measuring scale. This would more than likely not require any change in existing designs of measuring blades as there is plenty of open space above the printed numbers, as is the case of most rulers etc. The only modification would be to shorten some of the small fraction lines if they were found to interfere with the two newly printed numbers. It also applies to shorter measuring devices, rulers, yard sticks etc., with scales similar to FIG. 5. or FIG. 6.

The invention also applies to electronic multifunction digital tape rules that give digital readings or digital and traditional measurement readings. This would involve including the invention in the optical readers and microprocessor by the manufacturer.

The advantage of the invention over the transit is, the transit requires more set up time, much larger equipment, more expensive and less accurate. The advantages over using just the tape measure and having the different sets of numbers memorized is that memorizing larger number combinations become more difficult, more room for error and can be only done in a practical sense in three feet increments. The invention makes the task of squaring measurement's easer, faster, eliminates errors, produces measurements in as small as inches and is much more accurate.

1. The application of two numbers in consecutive order that along with a third number in one of three or more combinations form a 90 degree right triangle (a²+b²=c²) where a=altitude, b=base and c=hypotenuse on or in measuring devices that measure distance in equal increments.
a. Incorporating and printing two additional numbers that form a right triangle with existing designed formats or newly designed formats on blades of retractable tape measures, on rulers, yard sticks or other measuring instruments in either the standard or metric measuring system of measurement.
b. Incorporating into the optical readers and microprocessors of multifunction digital tape rules that display measurement readings and traditional blade measurement readings, two additional numbers that form a right triangle with existing designed formats or newly designed formats in either the standard or metric system of measurement.

2. The application by printing or otherwise, the cosine mathematical formula for calculating angles and a table of measurements of angles in one degree increments or larger degree increments and their cosines to be applied on the back of tape measure blades, on the sides or any other place of tape measure housings or any type of printed attachment along with instructions.
